(19) United States
(12) Patent Application Publication
(10) Pub. No.: US 2008/0236423 A1
(43) Pub. Date: Oct. 2, 2008

(54) CLEANING DEVICE FOR ROLLERS IN LITHOGRAPHIC PLATE MANUFACTURING

(76) Inventors: Harald Baumann, Osterode/Harz (DE); Udo Dwars, Herzberg/Harz (DE); Joerg Heinemann, Osterode (DE); Michael Mursal, Horden (DE); Marco Scala, Osterode (DE)

Correspondence Address: David A. Novais, Patent Legal Staff;Eastman Kodak Company, 343 State Street, Rochester, NY, 14650-2201, US

(21) Appl. No.: 11/693,390

(22) Filed: Mar. 29, 2007

(51) Int. Cl. B41F 35/04

(52) U.S. Cl. 101/425

(57) ABSTRACT

An apparatus and related method for preparing a lithographic web during manufacturing by incorporating a cleaning device cleaning device capable of being in contact with one or more web rollers. The cleaning device including a cleaning applicator to apply the cleaning solution such that the cleaning solution connected to the cleaning applicator, and a controller to move the applicator from an operational mode to a self-cleaning mode.

### FIELD OF THE INVENTION

This invention relates in general to a lithographic web manufacturing system and more specifically to an apparatus and method for cleaning rollers used during the manufacture of a lithographic precursor or web.

### BACKGROUND OF THE INVENTION

The manufacturing of lithographic printing webs or lithographic printing plate precursors, that have photopolymerizable layers, for lithographic printing is a multi step process that produces a number of layers on a substrate in preparation for later steps that place images on the precursor. The lithographic printing plate precursors or webs typically consist of an aluminum substrate suitable for lithographic printing with one or more photopolymerizable layers and optionally oxygen barrier layers.

In a typical manufacturing line, the layers laid down on the substrate of a continuous web needs to be contacted by many face rollers before subsequent application of the optional oxygen barrier layer and the cutting operation which converts the continuous web of coated plates into sheets of appropriate sizes for packaging and shipment to customers. During the application of these layers one or more surface rollers contact the layers while the layers are tacky, for example, resulting in contamination of the roller surfaces. The contaminated roller surfaces tend to disrupt the subsequent photopolymerizable layers on the continuous web and thereby renders subsequent printing plate precursor undesirable properties such as delays, non-uniformity and poor shelf life of the finished lithographic printing plate precursors. The contaminated roller surfaces can even ruin the web.

The rollers applying the layers to the aluminum substrate during manufacturing of the web require careful cleaning in order to prevent the delays and ruined products. Improper cleaning, including non-existent and/or excessive cleaning, results in downtime and considerable waste. One problem to be avoided is having the manufacturing rollers stick to the surface. Another is preventing manufacturing shutdown and stoppages due to manual cleaning processes to remove the residue formed during manufacturing.

These problems may be overcome by use of a specially designed and controlled cleaning device and automated method for self-cleaning.

### SUMMARY OF THE INVENTION

This invention is directed to invention relates in general to a lithographic plate system and more specifically to an apparatus and method for cleaning the rollers used in the manufacturing of a lithographic precursor.

The apparatus and related method include a cleaning device in contact with the manufacturing roller including at least one cleaning applicator to apply the cleaning solution and a controller to move the applicator from operational mode to self-cleaning mode.

### BRIEF DESCRIPTION OF THE DRAWINGS

FIG. 1 is a schematic drawing of a cleaning device, in which the method of the present invention may be implemented.

FIG. 2 is another embodiment of the cleaning device.

FIG. 3 is another embodiment of the cleaning device.

FIG. 4 is shows a manufacturing line for lithographic plates.

FIG. 5 is a schematic drawing of a flowchart of a cleaning method of the present invention that may be implemented.

### DETAILED DESCRIPTION OF THE INVENTION

Some terms used in the present invention include the term printing plate “precursor” or “web” which refers to a non-imaged plate or continuous web (i.e. a plate or web that has not been image-wise exposed and developed), from which a printing plate is produced by image-wise exposure and optionally developing. Also used is the term “printing plate” which refers to an already imaged plate produced from a printing plate precursor or web.

A dimensionally stable plate or foil-shaped material is preferably used as a substrate in particular in the production of printing plate precursors. Preferably, a material is used as dimensionally stable plate or foil-shaped material that has already been used as a substrate for printing matters. Examples of such substrates include paper, paper coated with plastic materials (such as polyethylene, polypropylene, polystyrene), a metal plate or foil, such as e.g. aluminum (including aluminum alloys), zinc and copper plates, plastic films made e.g. from cellulose diacetate, cellulose triacetate, cellulose propionate, cellulose acetate, cellulose acetatebutyrate, cellulose nitrate, polyethylene terephthalate, polyethylene, polystyrene, polypropylene, polycarbonate and polyvinyl acetate, and a laminated material made from paper or a plastic film and one of the above-mentioned metals, or a paper/plastic film that has been metallized by vapor deposition. Among these substrates, an aluminum plate or foil is especially preferred since it shows a remarkable degree of dimensional stability, is inexpensive and furthermore exhibits excellent adhesion to the coating. Furthermore, a composite film can be used wherein an aluminum foil has been laminated onto a polyethylene terephthalate film.

A metal substrate, in particular an aluminum substrate, is preferably subjected to at least one treatment selected from graining. This can include brushing in a dry state or brushing with abrasive suspensions, or electrochemical graining, e.g. by means of a hydrochloric acid electrolyte and/or anodizing e.g. in sulfuric acid or phosphoric acid and hydrophilizing.

In order to improve the hydrophilic properties of the surface of the metal substrate that has been grained and optionally anodized in sulfuric acid or phosphoric acid, the metal substrate can be subjected to an after-treatment with an aqueous solution of sodium silicate, calcium zirconium fluoride, polyvinylphosphonic acid or phosphoric acid. Within the framework of the present invention, the term “substrate” also encompasses an optionally pre-treated substrate exhibiting, for example, a hydrophilizing layer (so called “hydrophilic interlayer” on its surface. The details of the above-mentioned substrate pre-treatment are known to someone skilled in the art.

For producing a lithographic precursor, a radiation-sensitive coating is applied to the surface of the substrate by means of common processes (e.g. roller coating, slot coating, gravure coating). It is also possible to apply the radiation-sensitive composition on both sides of the substrate; however, for the elements of the present invention, it is preferred that the radiation-sensitive coating be only applied to one side of the substrate.

For this purpose, the radiation-sensitive composition comprises one or more organic solvents. Suitable solvents include low alcohols (e.g. methanol, ethanol, propanol and butanol), glycolether derivatives (e.g. ethyleneglycol monomethylether, ethyleneglycol dimethylether, propyleneglycol monomethylether, ethyleneglycol monomethylether acetate, ethyleneglycol monoethylether acetate, propyleneglycol monomethylether acetate, propyleneglycol monoethylether acetate, ethyleneglycol monoisopropylether acetate, ethyleneglycol monobutylether acetate, diethyleneglycol monomethylether, diethyleneglycol monoethylether), ketones (e.g. diacetone alcohol, acetyl acetone, acetone, methyl ethyl ketone, cyclohexanone, methyl isobutyl ketone), esters (e.g. z. B. methyl lactate, ethyl lactate, ethyl acetate, 3-methoxypropyl acetate and butyl acetate), aromatics (e.g. toluene and xylene), cyclohexane, 3-methoxy-2-propanol, 1-methoxy-2-propanol, methoxymethoxyethanol, y-butyrolactone and dipolar aprotic solvents (e.g. THF, dimethylsulfoxide, dimethylformamide and N-methylpropyrrolidone). The solids content of the radiation-sensitive mixture to be applied depends on the coating method that is used and is preferably 1 to 50 wt.-%.

The additional application of a second coating with a solvent or solvent mixture preventing substantially intermixing with the first coating can be advantageous. If the first coating is based on radical photopolymerization the second coating comprises preferred a water-soluble oxygen-impermeable polymer. The polymers suitable for such an overcoat include, inter alia, polyvinyl alcohol, polyvinyl alcohol/polyvinyl acetate copolymers, polyvinyl pyrrolidone, polyvinyl pyrrolidone/polyvinyl acetate copolymers, polyvinyl methylethers, ring-opened copolymers of maleic acid anhydride and a comonomer such as methylvinylether, polyacrylic acid, cellulose ether, gelatin, etc.; polyvinyl alcohol is preferred.

Preferably, the composition for the oxygen-impermeable overcoat is applied in the form of a solution in water or in a solvent miscible with water; in any case, the solvent is selected such that the radiation-sensitive coating already present on the substrate does not dissolve. The layer weight of the overcoat can e.g. be 0.1 to 6 g/m2, preferably 0.5 to 6 g/m2. However, the printing plate precursors according to the present invention show excellent properties even without an overcoat. The overcoat can also comprise matting agents (i.e. organic or inorganic particles with a particle size of 2 to 20 μm), which facilitate the planar positioning of the film during contact exposure. In order to improve adhesion of the overcoat to the radiation-sensitive layer, the overcoat can comprise adhesion promoters such as e.g. poly (vinylpyrrolidone), poly(ethyleneimine) and poly (vinylimidazole). Suitable overcoats are described for example in WO 99/06890.

During the manufacturing of the lithographic web when the various layers of material is applied to the web, for example the application of a photopolymer layer there are periods of time when these layers can be soft and tacky, especially when the coating first exits from the coating drying oven on the plate manufacturing line. Since the continuous web of substrates needs to be contacted by many face or lithographic manufacturing rollers before being converted into sheets of appropriate sizes for packaging and shipment to customers this can cause materials to stick to the manufacturing rollers resulting in the transfer of material from the layer to the roller surface, resulting in combination of the roller surfaces.

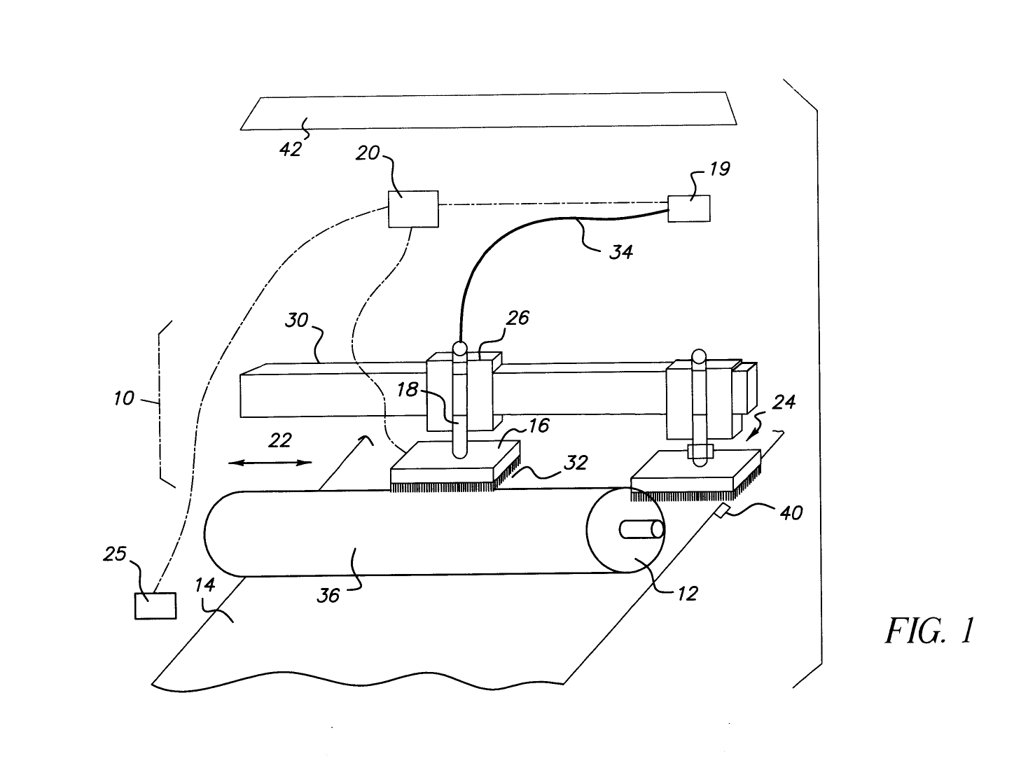

FIG. 1 shows a lithographic web roller cleaning device 10 for a lithographic web roller 12 used during the manufacture of a lithographic precursor or web 14. The cleaning device 10 includes at least one cleaning applicator 16 to apply a cleaner 18, such as a cleaning solution 18. FIG. 1 shows a supply 19 of cleaning solution or liquid that is connected to the cleaning applicator 16 so that a controller 20 that can also move the applicator from operational mode 22 to a self-cleaning mode 24 can also control the supply of the solution 18 as well as other related steps discussed below. The operational mode includes placing one or more web rollers proximate a non-coated exposed portion of the lithographic web and placing the web roller cleaning device in communication with the lithographic web roller to remove residue. The self-cleaning mode includes a web roller-cleaning device cleaner to remove residue form the web roller-cleaning device.

The controller 20 uses input from manufacturing information including, one or more of a sensor, timer, electrical information and process chemical information. The controller 20 is also capable of communicating with the web through one or more sensors 25 as well as various other controllers and sensors that control other steps of the manufacturing process. This allows the coating process to be stopped as needed to allow cleaning of the applicator without stopping other processes and thus resulting in an automated process.

The roller cleaning device 10 shown has a brush cleaning support 26. A linear transporting unit 30 moves the applicator 16, shown here as a brush roller or brush unit 32 that is connected with a cleaning liquid supply tube 34 in contact with a roller surface 36. During the operational mode 22 the roller 12 rotates and the cleaning liquid 18 is continuously supplied through the supply tube 34 as controlled by the controller 20.

In one embodiment, after several cleaning cycles the brush unit 32 is automatically moved to the self-cleaning mode 24 where a web roller cleaning device 40, such as a cleaning blade, cleans the roller 12. In this embodiment the roller moves several times over the cleaning blade 40 so that the brush unit is cleaned before it moves back to the operational mode 22. An exhaustion system 42 is added when needed to take care of the removal of solids, liquids and/or vapors. This is especially useful in case of using solvents for cleaning and may be installed above the brush unit as shown in FIG. 1. Other alternatives to the fixed brush roller and/or brush unit 32 can be used as the applicator as will be discussed below. Any device that is controllable and can apply a cleaner can be used as the cleaning applicator including a rotating brush or belt.

The cleaning applicator or apparatus 16 in the form of a brush, roller and/or belt is used such that the cleaning applicator is alternately in contact with the roller surface 36 as needed to clean the surface. It is also in contact with a cleaning solution, such as one with an organic solvent as needed. The cleaning device is capable of cleaning the cleaning applicator uses a variety of self-cleaning devices and related methods including the self-cleaning blade 40 that contacts the cleaning applicator to remove residue. The residue can be disposed of in a container 48 that can receive the residue, such as being in contact with the cleaning applicator 16. The cleaning solution 18 can be continuously supplied to the cleaning applicator 16 through the hose or tube 34 as well as be available in a vat that the cleaning applicator 16 moves through. The timing of the cleaning of the lithographic web roller 12 and the cleaning applicator 16 can be coordinated with the manufacturing steps as well as with other related activities to maximize efficiency and quality of the plate manufacturing process.

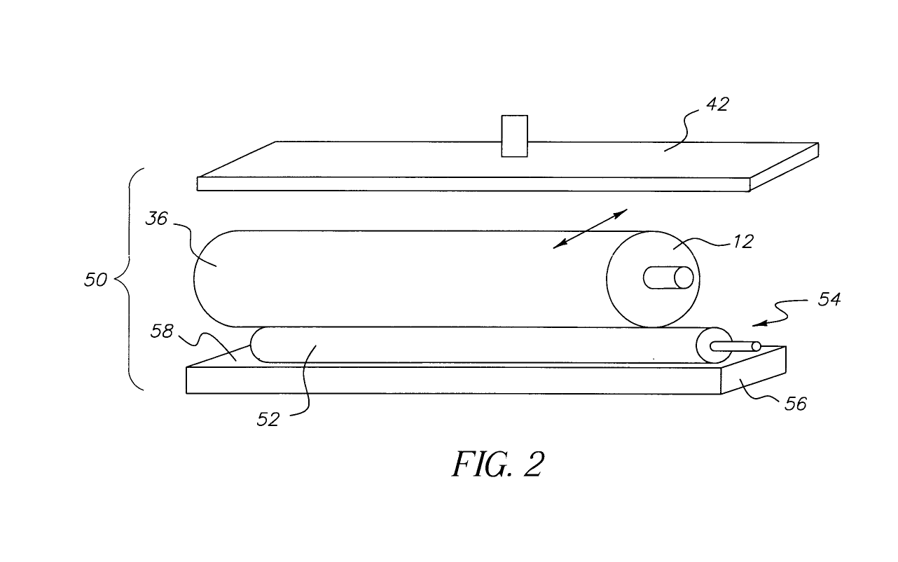

FIG. 2 shows another embodiment of the cleaning device 50. A roller cleaning device 52 in contact with the surface 36 of a roller 12 and supported on a brush cleaning support 54 that is also a cleaning liquid supply 19. In this embodiment the applicator or scrub brush cleaning roller 52 is installed parallel to the roller 12 that has to cleaned. The scrub brush roller 52 is capable of dipping into the cleaning liquid 18 in the cleaning tank 56 in the brush cleaning support 54, which also contains a blade 58 in contact to the scrub brush roller 52 to remove residue. The exhaustion system 42 is installed above the cleaning device 50 for removing evaporated solvent.

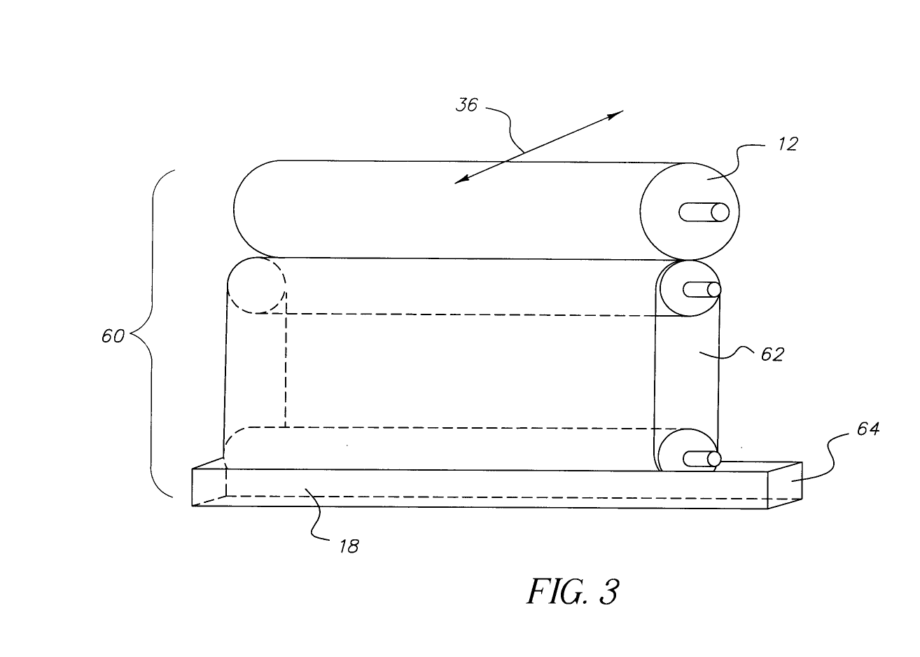

FIG. 3 shows another embodiment of the cleaning device 60 including a cleaning/polishing belt 62 in contact with the roller 36 of the roller 12 to be cleaned. The belt 62 removes residue from the roller 12 and transports it into a container 64 with the cleaning liquid 18.

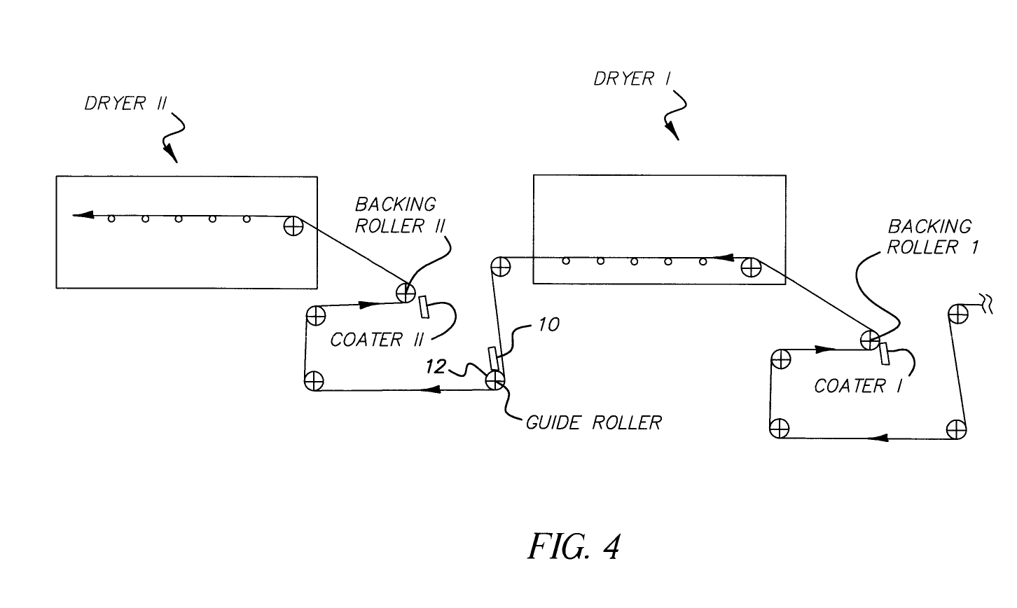

The cleaning of the roller surfaces in lithographic web manufacturing lines is challenging because the rollers come into contact with one or more photopolymer coatings throughout the process. FIG. 4 shows an example of a manufacturing line for lithographic plates having a two coating stations and two dryers for application of a photopolymer bottom coat and a oxygen barrier top coat. The lithographic web roller cleaning device 10 is used in conjunction with one or more lithographic web rollers 12 that are used during the manufacture of a lithographic precursor or web 14. The guide roller 12 is an example of one roller that would be cleaned, as described, by the lithographic web roller cleaning device 10 positioned as shown, in FIG. 4, next to the roller 12 in the during the lithographic precursor or web manufacturing line.

Photopolymer type of coating tends to be tacky which predisposes this manufacturing process to undesired residues on the final product. As a result of the tackiness it is common for the roller to acquire a deposition of material or residue on the roller surface that comes into contact with photopolymers. This results in web defects those unacceptable and manufacturing stoppages that lead to inefficiencies and defective final products. Defects that may not be observable until the plates are imaged weeks or months later at locations far removed from the manufacturing location. To ensure production of plates without defects the rollers have to be cleaned with cleaning liquids, which are in most cases these organic solvents. Currently the operators clean the rollers manually, which is time consuming and undesired from health and safety point of view.

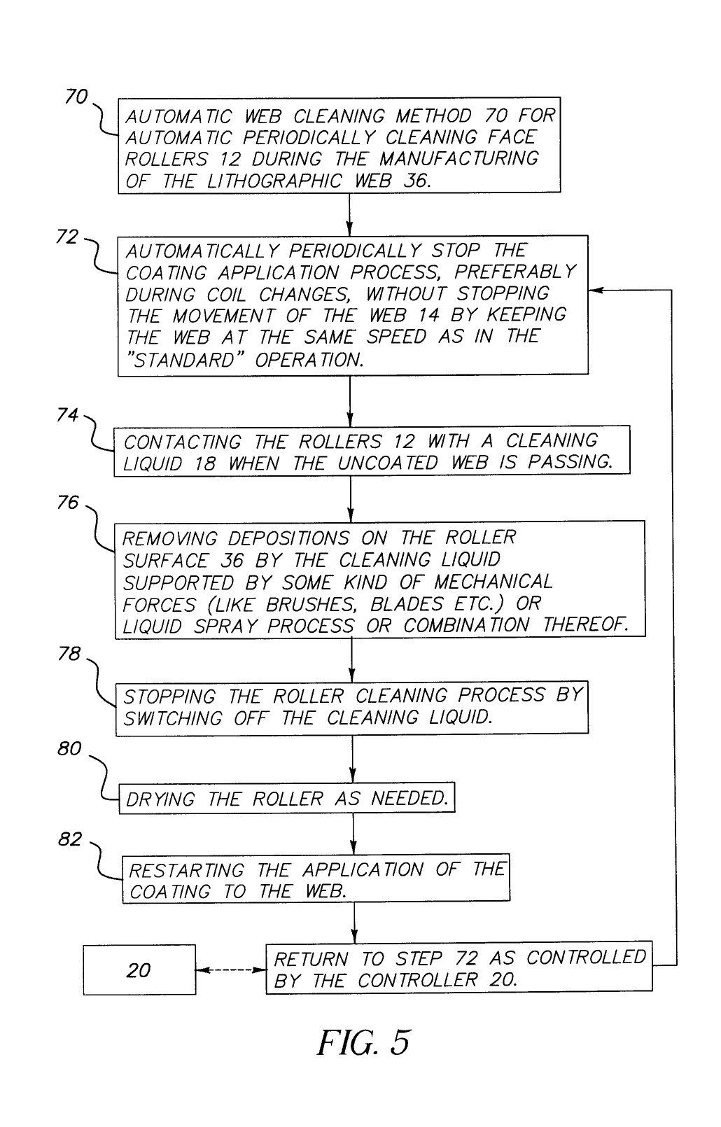

FIG. 5 is a flow chart of the steps of an automatic web cleaning method 70 for periodically cleaning the rollers 12 during the manufacturing of the lithographic web 36 starts by stopping the coating application process 72, preferred during coil changes, without stopping the movement of the web 14 by keeping the web at the same speed, preferably by keeping the web at the same speed as in the “standard” operation. The automated stoppage is controlled by controller 20 and may be set at a preset time or time interval or can be based on one or more sensor readouts or environmental conditions. The coating process is stopped for a time period long enough to remove the required amount of residue and may be controlled by similar conditions such as a preset time or time interval or can also be based on one or more sensor readouts or environmental conditions. The roller(s) for example can be color coded for cleaning levels such as blue for clean and brown with contamination or use other sensory indicators to show a level of cleanliness necessary for manufacturing defect free coatings.

The next step 74 of the method places the rollers in contact with the cleaner 18, such as a cleaning liquid with organic solvents, when an uncoated web is passing by the roller so that the solvent that is used during the cleaning of the roller will not affect the coating process. Note that this non-coated exposed portion of the lithographic web can have one or more coatings. Enough uncoated web must be available to the roller whole it is being cleaned to allow at least one complete rotation of the roller which would be at a minimum of the circumference of the roller so if the roller has a diameter of 5 cm or 50 cm then at least an amount of the web must be exposed that equals or exceeds the rollers circumference. In some embodiments this may actually take hundreds of rotations before the residue is removed, for example by being dissolved by a solvent that is in contact with the roller.

The next step 76 involves removing the residue on the roller surface 36 by applying the cleaning liquid 18 with the applicator 22, such as brushes, blades etc. or alternately a liquid spray process or combination thereof. The next step 78 is to stop the cleaning process by switching off the cleaning liquid and stopping the mechanical support of cleaning if required. This step can be also automated by the use of at a time interval or be based on one or more sensor readouts or environmental conditions as well as color-coded. Next the method uses a step 80 to dry the roller 12, if necessary, so that there are no residue solvents or other cleaners on the roller that would disturb the coating process and final product. Finally in step 82 the coating process is restarted again. The controller 20 then can return the lithographic web roller cleaning device 10 to the first step or any other step as needed.

The invention has been described in detail with particular reference to certain preferred embodiments thereof, but it will be understood that variations and modifications can be effected within the spirit and scope of the invention.

1. A web roller cleaning device used during the coating of lithographic webs using web rollers, wherein the web roller-cleaning device comprises:
at. at least one cleaning applicator to apply the cleaning solution;
b. a supply of cleaning solution connected to the cleaning applicator; and
c. a controller to move the cleaning applicator to one of an operational mode or a self-cleaning mode.

2. The apparatus of claim 1, wherein the operational mode comprises placing one or more web rollers proximate a non-coated exposed portion of the lithographic web and placing the web roller cleaning device in communication with the lithographic web roller to remove residue.

3. The apparatus of claim 2, wherein the non-coated exposed portion of the lithographic web has one or more coatings.

4. The apparatus of claim 1, wherein the self-cleaning mode further comprises a web roller-cleaning device cleaner to remove residue form the web roller-cleaning device.

5. The apparatus of claim 4, wherein web roller cleaning device cleaner further comprises one or more extraction systems for cleaning solution removal.

6. The apparatus of claim 4, wherein the web roller-cleaning device cleaner comprises a cleaning blade.

7. The apparatus of claim 6, wherein the cleaning applicator is alternately in contact with the exposed surface and the cleaning blade while the cleaning solution is continuously supplied.

8. The apparatus of claim 1, wherein the controller uses input from manufacturing information including one or more of a sensor, timer, electrical information and process chemical information.

9. The apparatus of claim 1, wherein the cleaning solution further comprises a solution having water and/or an organic solvent.

10. The apparatus of claim 1, wherein web roller cleaning applicator further comprises one or more of a brush, roller and belt.

11. The apparatus of claim 10, wherein the cleaning applicator is rotated.

12. The apparatus of claim 1, wherein the cleaning applicator deposits the cleaning residue into a container coupled to the cleaning applicator.

13. The apparatus of claim 1, wherein the cleaning applicator is dipped into the cleaning solution.

14. A method for automatic cleaning a lithographic web roller during a lithographic web coating process comprising the steps of:
a. stopping a lithographic web manufacturing process to place a non-coated exposed portion of a lithographic web proximate a lithographic web roller;
b. placing a cleaning device in communication with the lithographic web roller to remove residue from the roller;
c. cleaning the cleaning apparatus to remove the residue;
d. restarting the manufacturing process; and
e. automatically controlling one or more of steps a to d in conjunction with the manufacturing of the lithographic plate.

15. The method of claim 14, wherein one or more automatic step further comprises a controller in response to at least one of a time period or a sensor reading.

16. The method of claim 14, wherein the method further comprises drying the roller to remove all cleaning solution prior to restarting manufacturing.

17. The method of claim 14, wherein the method further comprises stopping the process for a time period sufficient to remove all residue on a roller necessary to continue to manufacture quality plates.

18. The method of claim 17, wherein the time period is a minimum of time to expose the circumference of the roller to the exposed web.

19. The method of claim 14, wherein cleaning solution further comprises a solution having water and/or an organic solvent.

20. The method of claim 14, wherein the cleaning application further comprises one or more of a brush, roller and belt.

21. The method of claim 20, wherein the cleaning applicator is alternately in contact with the roller surface and a cleaning blade while the cleaning solution is continuously supplied.

22. The method of claim 21, wherein the cleaning applicator is rotated.

23. The method of claim 14, wherein the cleaning applicator deposits the cleaning residue into a container coupled to the cleaning applicator.

24. The method of claim 14, wherein the cleaning applicator is dipped into the cleaning solution.

25. A lithographic web roller manufacturing system comprising:
a. a lithographic web in contact with one or more rollers;
b. a supply of cleaning solution in communication with the one or more rollers;
c. a cleaning device, wherein the cleaning device comprises at least one cleaning applicator to apply the cleaning solution; and
d. a controller to move the cleaning applicator to one of an operational mode or a self-cleaning mode.
